(19) United States
(12) Patent Application Publication
(10) Pub. No.: US 2022/0073109 A1
(43) Pub. Date: Mar. 10, 2022

(54) VEHICLE CONTROL UNIT

(71) Applicant: DENSO CORPORATION, Kariya-city (JP)

(72) Inventor: Yuji OTA, Kariya-city (JP)

(21) Appl. No.: 17/529,379

(22) Filed: Nov. 18, 2021

Related U.S. Application Data
(63) Continuation of application No. PCT/JP2020/018969, filed on May 12, 2020.

(30) Foreign Application Priority Data
May 21, 2019 (JP) 2019-095249

(51) Int. Cl. B60W 60/00; B60W 50/14

(52) U.S. Cl. CPC B60W 60/0055; B60W 50/14; B60W 2540/103; B60W 2552/05; B60W 2540/18; B60W 2552/30; B60W 2050/146

(57) ABSTRACT

A vehicle control device includes a specific scene determination unit, a specific operation determination unit, a function-off unit, and a threshold value setting unit. The specific scene determination unit is configured to determine whether the vehicle is in a specific scene. The specific operation determination unit is configured to determine whether a driver of the vehicle performed a specific operation. The function-off unit is configured to turn off at least one of functions of the automated driving when the specific scene determination unit determines that the vehicle is in the specific scene and the specific operation determination unit determines that the driver performed the specific operation. The specific operation includes an operation on the accelerator pedal with a depression amount exceeding an accelerator threshold value. The threshold value setting unit is configured to set the accelerator threshold value depending on a scene where the vehicle is traveling.

### CROSS REFERENCE TO RELATED APPLICATION

The present application is a continuation application of International Patent Application No. PCT/JP2020/018969 filed on May 12, 2020, which designated the U.S. and claims the benefit of priority from Japanese Patent Application No. 2019-095249 filed on May 21, 2019. The entire disclosures of all of the above applications are incorporated herein by reference.

### TECHNICAL FIELD

The present disclosure relates to a vehicle control device.

### BACKGROUND

In recent years, automated vehicles have been attracting attention. General automated vehicles are configured to perform an automated driving and a manual driving. When a driver operates a brake pedal during the automated driving, functions of the automated driving are turned off.

### SUMMARY

According to a first aspect of the present application, a vehicle control device for a vehicle configured to perform an automated driving and a manual driving includes a specific scene determination unit, a specific operation determination unit, a function-off unit, and a threshold value setting unit. The specific scene determination unit is configured to determine whether the vehicle is in a specific scene that is predetermined. The specific operation determination unit is configured to determine whether a driver of the vehicle performed a specific operation including an operation on an accelerator pedal. The function-off unit is configured to turn off at least one of functions of the automated driving when the specific scene determination unit determines that the vehicle is in the specific scene and the specific operation determination unit determines that the driver performed the specific operation during the automated driving. The specific operation includes an operation on the accelerator pedal with a depression amount of the accelerator pedal exceeding an accelerator threshold value. The threshold value setting unit is configured to set the accelerator threshold value depending on a scene where the vehicle is traveling.

According to a second aspect of the present application, a vehicle control device for a vehicle configured to perform an automated driving and a manual driving includes a specific scene determination unit, a specific operation determination unit, a function-off unit, and a threshold value display unit. The specific scene determination unit is configured to determine whether the vehicle is in a specific scene that is predetermined. The specific operation determination unit is configured to determine whether a driver of the vehicle performed a specific operation including an operation on an accelerator pedal. The function-off unit is configured to turn off at least one of functions of the automated driving when the specific scene determination unit determines that the vehicle is in the specific scene and the specific operation determination unit determines that the driver performed the specific operation during the automated driving. The specific operation includes an operation on the accelerator pedal with a depression amount of the accelerator pedal exceeding an accelerator threshold value. The threshold value display unit is configured to display the accelerator threshold value.

According to a third aspect of the present application, a vehicle control device for a vehicle configured to perform an automated driving and a manual driving includes a specific scene determination unit, a specific operation determination unit, and a function-off unit. The specific scene determination unit is configured to determine whether the vehicle is in a specific scene that is predetermined. The specific operation determination unit is configured to determine whether a driver of the vehicle performed a specific operation including an operation on an accelerator pedal. The function-off unit is configured to turn off at least one of functions of the automated driving when the specific scene determination unit determines that the vehicle is in the specific scene and the specific operation determination unit determines that the driver performed the specific operation during the automated driving. The specific operation includes an operation on the accelerator pedal continuing for a predetermined time.

According to a fourth aspect of the present application, a vehicle control device for a vehicle configured to perform an automated driving and a manual driving includes a specific scene determination unit, a specific operation determination unit, a function-off unit, and a notification unit. The specific scene determination unit is configured to determine whether the vehicle is in a specific scene that is predetermined. The specific operation determination unit is configured to determine whether a driver of the vehicle performed a specific operation including an operation on an accelerator pedal. The function-off unit is configured to turn off at least one of functions of the automated driving when the specific scene determination unit determines that the vehicle is in the specific scene and the specific operation determination unit determines that the driver performed the specific operation during the automated driving. The notification unit is configured to notify a turn off of the at least one of the functions of the automated driving before the function-off unit turns off the at least one of the functions.

### BRIEF DESCRIPTION OF THE DRAWINGS

FIG. 1 is a block diagram illustrating a vehicle control device.

FIG. 2 is a block diagram illustrating a functional configuration of the vehicle control device.

FIG. 3 is a flowchart illustrating a process executed by the vehicle control device.

### EMBODIMENTS

The present inventor found the following. When the functions of the automated driving are on and the vehicle is traveling in a specific scene, the driver may require to drive at a speed higher than the speed set by the functions of the automated driving. The specific scene includes, for example, a scene at an exit ramp of a freeway. When the driver requires to drive at a speed higher than the speed set by the functions of the automated driving, the driver needs to turn the functions of the automated driving off by operating the brake pedal or the like.

Exemplary embodiments of the present disclosure will be described with reference to the drawings.

### First Embodiment

### 1. Configurations of Vehicle Control Device

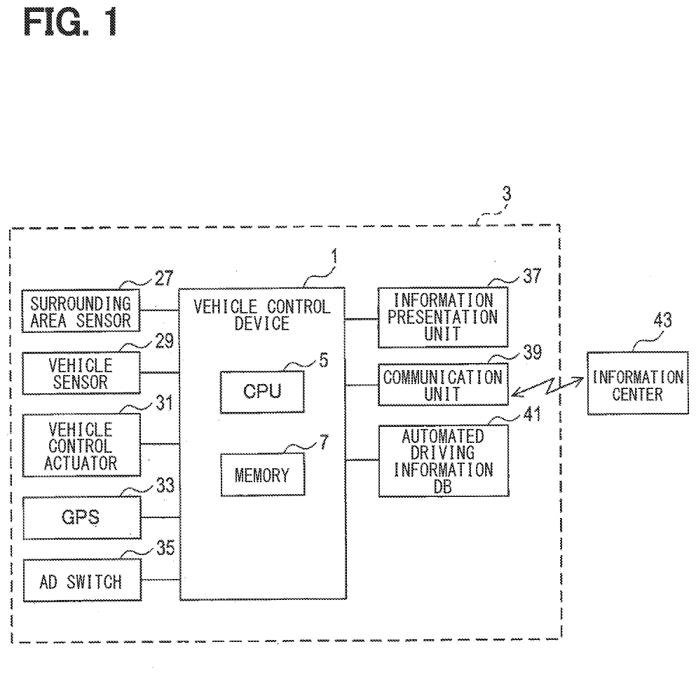

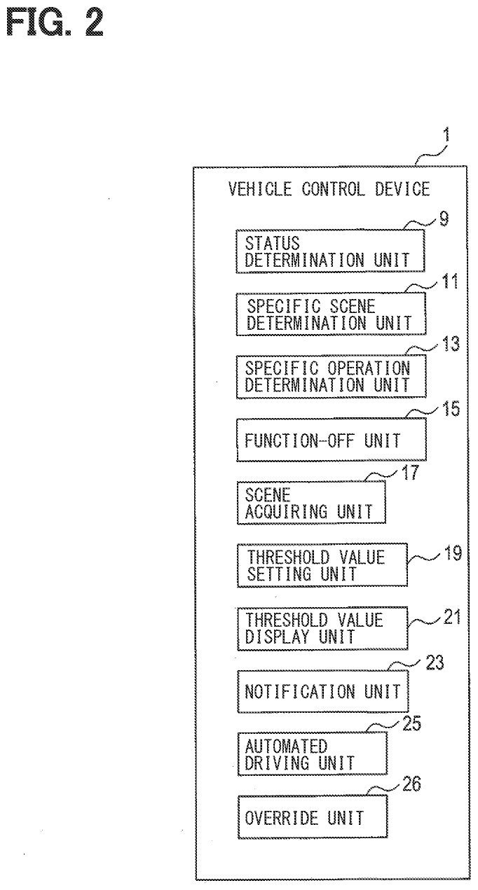

Configurations of a vehicle control device 1 will be described with reference to FIGS. 1, 2. As shown in FIG. 1, the vehicle control device 1 is installed in a vehicle 3. The vehicle 3 is configured to perform an automated driving and a manual driving. Hereinafter, automated driving may be referred to as AD. A state where the automated driving function is on may be referred to as AD-on. A state where the automated driving function is off may be referred to as AD-off. AD-off is a state where a driver of the vehicle 3 manually drives the vehicle 3.

The state of the vehicle 3 is switched from AD-on to AD-off by the process of step S3 described later. The state of the vehicle 3 is switched from AD-off to AD-on by a known trigger.

The vehicle control device 1 includes a microcontroller having a CPU 5 and a semiconductor memory (hereinafter, a memory 7) such as a RAM and a ROM, for example.

Respective functions of the vehicle control device 1 are realized by the CPU 5 executing a program stored in a non-transitory tangible storage medium. In this embodiment, the memory 7 corresponds to the non-transitory tangible storage medium in which the programs are stored. A method corresponding to the program is realized by the execution of the program. The vehicle control device 1 may include one microcomputer, or may include a plurality of microcomputers.

As shown in FIG. 2, the vehicle control device 1 includes a status determination unit 9, a specific scene determination unit 11, a specific operation determination unit 13, a function-off unit 15, a scene acquiring unit 17, a threshold value setting unit 19, a threshold value display unit 21, a notification unit 23, an automated driving unit 25, and an override unit 26.

As shown in FIG. 1, the vehicle 3 includes a surrounding area sensor 27, a vehicle sensor 29, a vehicle control actuator 31, a GPS 33, an AD switch 35, an information presentation unit 37, a communication unit 39, and an automated driving information database 41. The vehicle control device 1 is connected with these units.

The surrounding area sensor 27 is configured to detect objects around the vehicle 3. The surrounding area sensor 27 includes a camera, a Lidar, and the like. The vehicle sensor 29 is configured to detect operations by the driver of the vehicle 3. The operations include an operation on an accelerator pedal, an operation on a brake pedal, and an operation on a steering wheel. The vehicle sensor 29 is configured to detect the depression amount of the accelerator pedal, the depression amount of the brake pedal, and the operation amount of the steering wheel.

The vehicle control actuator 31 is configured to control a traveling state of the vehicle 3 in accordance with instructions from the vehicle control device 1. The control includes acceleration, deceleration, steering, and the like. The GPS 33 is configured to acquire location information of the vehicle 3.

The AD switch 35 is a switch that can be operated by the driver. The operation of the AD switch 35 triggers the state of the vehicle 3 to switch from AD-on to AD-off. The operation of the AD switch 35 triggers the state of the vehicle 3 to switch from AD-off to AD-on.

The information presentation unit 37 is provided in a passenger compartment of the vehicle 3. The information presentation unit 37 has, for example, a display and a speaker. The information presentation unit 37 is configured to provide information to the driver by image or sound.

The communication unit 39 is configured to perform wireless communication with an information center 43 outside the vehicle 3. The communication unit 39 is configured to receive traffic information, weather information, map information described later, and the like from the information center 43, for example.

The automated driving information database 41 stores the map information and the like. The map information contains road profiles, the number of lanes on the road, speed limit of the road, location of intersections, location of crosswalks, and the like.

### 2. Process Executed by Vehicle Control Device 1

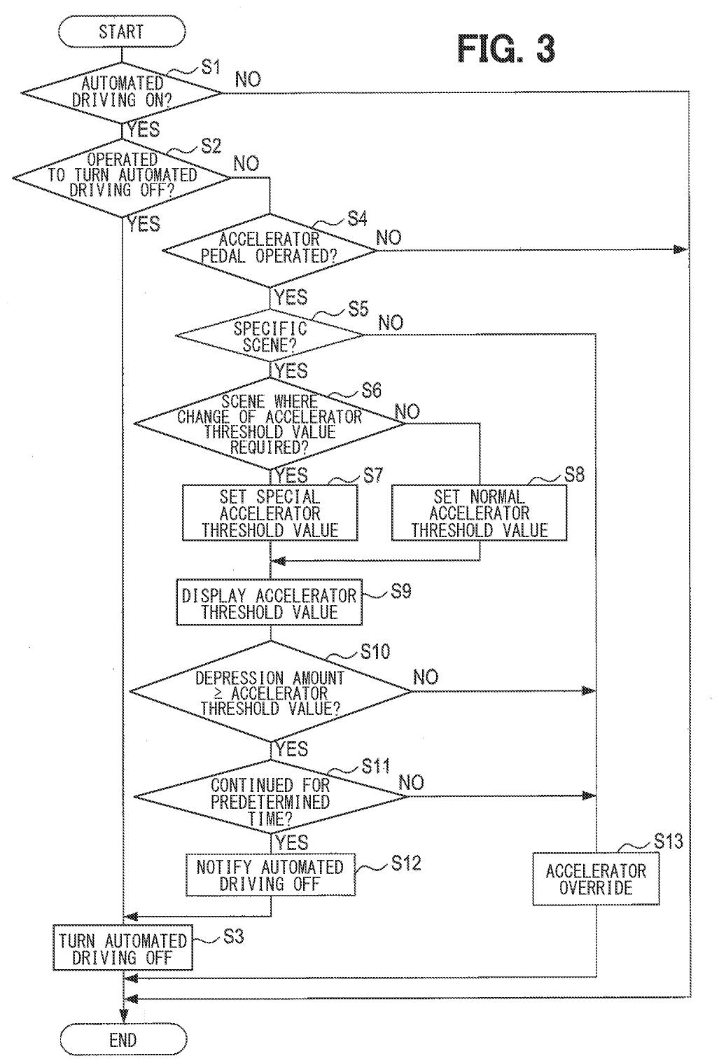

Processes repeatedly executed by the vehicle control device 1 at predetermined time intervals will be described with reference to FIG. 3. In step S1 of FIG. 3, the status determination unit 9 determines whether the automated driving is on. When it is determined that the automated driving is on, the process proceeds to step S2. When it is determined that the automated driving is off, the process ends and the automated driving keeps being off.

In step S2, the function-off unit 15 determines whether the driver performed an operation to turn the automated driving off. The operation to turn the automated driving off includes the operation of the AD switch 35, the operation on the brake pedal, the operation on the steering wheel, and the like. The function-off unit 15 is configured to detect the operation on the brake pedal and the operation on the steering wheel using the vehicle sensor 29. When the driver performed the operation to turn the automated driving off, the process proceeds to step S3. When the driver did not perform the operation to turn the automated driving off, the process proceeds to step S4.

In step S3, the function-off unit 15 switches the state of the vehicle 3 from AD-on to AD-off.

In step S4, the specific operation determination unit 13 determines whether the driver operated the accelerator pedal. The specific operation determination unit 13 is configured to detect the operation on the accelerator pedal using the vehicle sensor 29. When the driver operated the accelerator pedal, the process proceeds to step S5. When the driver did not operate the accelerator pedal, the process ends and the automated driving keeps being on. When the automated driving keeps being on, the automated driving unit 25 performs the automated driving by a known method using the surrounding area sensor 27, the vehicle control actuator 31, the GPS 33, the automated driving information database 41, and the like.

In step 5, the scene acquiring unit 17 first acquires the scene where the vehicle 3 is present at the moment (hereinafter, referred to as the current scene). The scene is the location. The scene acquiring unit 17 is configured to acquire the current scene by referring the location information of the vehicle 3 acquired by the GPS 33 and the map information stored in the automated driving information database 41.

Alternatively, the scene acquiring unit 17 is configured to detect landmarks around the vehicle 3 using the surrounding area sensor 27, for example. Examples of the landmarks include buildings, the topography, and the like. Subsequently, the scene acquiring unit 17 acquires the relative position information of the vehicle 3 with respect to the detected landmark. The scene acquiring unit 17 acquires the absolute position information of the detected landmark using the map information. The scene acquiring unit 17 acquires the current scene based on the relative position information of the vehicle 3 with respect to the detected landmark and the absolute position information of the detected landmark.

The specific scene determination unit 11 determines whether the current scene is a predetermined specific scene. The specific scene is, for example, a scene where the driver often desires to turn the automated driving off to drive at a vehicle speed higher than the vehicle speed set by the automated driving function. The specific scene is, for example, a scene where the vehicle speed set by the automated driving function is lower than that set in other scenes. The specific scene include a scene at an entrance ramp, a scene at an exit ramp, a scene at a ramp, a scene immediately before an ETC (registered trademark) gate, a scene immediately after the ETC gate, a scene before a curve, and the like.

When the current scene is the specific scene, the process proceeds to step S6. When the current scene is not the specific scene, the process proceeds to step S13.

In step S6, the threshold value setting unit 19 determines whether the current scene acquired in step S5 is a scene where the accelerator threshold value needs to be changed (hereinafter, referred to as a threshold value changing scene). The threshold value changing scene is set in advance. The threshold value changing scene is, for example, a scene where an appropriate vehicle speed for safe driving is different from other scenes. The threshold value changing scene includes a scene at a curve having a small curvature, a scene near ETC, and the like. The accelerator threshold value is a threshold value used for the determination in step S10.

When the current scene is the threshold value changing scene, the process proceeds to step S7. When the current scene is not the threshold value changing scene, the process proceeds to step S8.

In step S7, the threshold value setting unit 19 sets a special accelerator threshold value as the accelerator threshold value. The special accelerator threshold value is a positive value smaller than a normal accelerator threshold value described later.

In step S8, the threshold value setting unit 19 sets the normal accelerator threshold value as the accelerator threshold value. The normal accelerator threshold value is a positive value greater than the special accelerator threshold value. The accelerator threshold value is set in steps S6-8 depending on the scene where the vehicle 3 is traveling.

In step S9, the threshold value display unit 21 displays the accelerator threshold value set in step S7 or S8 using the information presentation unit 37.

In step S10, the specific operation determination unit 13 determines whether the depression amount of the accelerator pedal is at or above the accelerator threshold value set in the step S7 or S8. When the depression amount of the accelerator pedal is at or above the accelerator threshold value, the process proceeds to step S11. When the depression amount of the accelerator pedal is less than the accelerator threshold value, the process proceeds to step S13.

In step S11, the specific operation determination unit 13 determines whether the operation on the accelerator pedal has continued for a predetermined time. When the operation on the accelerator pedal has continued for the predetermined time, the process proceeds to step S12. When the operation on the accelerator pedal has not continued for the predetermined time, the process proceeds to step S13.

In step S12, the notification unit 23 notifies that the automated driving is going to be turned off using the information presentation unit 37. Subsequent to step S12, the process proceeds to step S3.

In step S13, the override unit 26 performs accelerator override. The accelerator override is a process to set the throttle opening degree to a value corresponding to the accelerator pedal operation by the driver while the automated driving is on.

### 3. Effects of the Vehicle Control Device 1

(1A) The vehicle control device 1 is configured to determine in step S5 whether the vehicle 3 is in the specific scene. Further, the vehicle control device 1 is configured to determine in steps S4, S10, S11 whether the depression amount of the accelerator pedal exceeds the accelerator threshold value and the operation on the accelerator pedal by the driver has continued for the predetermined time. When the vehicle control device 1 determines while the automated driving is on that: the vehicle 3 is in the specific scene; the depression amount of the accelerator pedal exceeds the accelerator threshold value; and the operation on the accelerator pedal by the driver has continued for the predetermined time, the vehicle control device 1 switches the state of the vehicle 3 to AD-off.

Accordingly, the vehicle control device 1 is configured to switch the state of the vehicle 3 to AD-off even if the driver does not necessarily perform the operation on the brake pedal. The operation on the accelerator pedal with the depression amount exceeding the accelerator threshold value and the operation on the accelerator pedal continuing for the predetermined time correspond to the specific operation.

(1B) The specific operation includes the operation on the accelerator pedal with the depression amount exceeding the accelerator threshold value. Accordingly, the vehicle control device 1 avoids a situation where the automated driving is turned off when the driver does not desire it.

(1C) The vehicle control device 1 is configured to selectively set the accelerator threshold value according to the scene where the vehicle 3 is traveling by the process in steps S6-8.

(1D) The vehicle control device 1 is configured to display the accelerator threshold value. Accordingly, it is easy for the driver to understand how much the accelerator pedal should be operated to turn the automated driving off.

(1E) The specific operation includes the operation on the accelerator pedal continuing for the predetermined time. Accordingly, the vehicle control device 1 avoids a situation where the automated driving is turned off when the driver does not desire it.

(1F) The specific scene includes the scene at an entrance ramp and the scene at an exit ramp. In the scene at an entrance ramp and the scene at an exit ramp, the driver is likely to desire to switch the state of the vehicle 3 to AD-off. The vehicle control device 1 is configured to switch the state of the vehicle 3 to AD-off in the scene at an entrance ramp and the scene at an exit ramp.

(1G) The vehicle control device 1 is configured to notify it before the automated driving is turned off. Accordingly, it is easy for the driver to understand a future state of the vehicle 3.

### Second Embodiment

1. Differences from First Embodiment

Since the basic configuration of a second embodiment is similar to the first embodiment, the differences will be described below. Note that the same reference signs as those in the first embodiment indicate the same configuration, and refer to the preceding descriptions.

In the first embodiment, the specific operation includes the operation on the accelerator pedal with the depression amount exceeding the accelerator threshold value and the operation on the accelerator pedal continuing for the predetermined period. In contrast, in the second embodiment, the specific operation includes an operation on the steering wheel in addition to the specific operation described in the first embodiment. That is, the specific operation in the second embodiment corresponds to a combination of the operation on the accelerator pedal and the operation on the steering wheel.

### 2. Effects of the Vehicle Control Device 1

According to the second embodiment described in detail above, the following effects are further obtained in addition to the effects of the first embodiment described above.

(2A) As described above, in the second embodiment, the specific operation in the second embodiment corresponds to a combination of the operation on the accelerator pedal and the operation on the steering wheel. The specific scene includes a scene before a curve. Accordingly, the vehicle control device 1 is configured to switch the state of the vehicle 3 to AD-off in the scene before a curve when both the operation on the accelerator pedal and the operation on the steering wheel are performed. Therefore, since the state of the vehicle 3 is not changed to AD-off when only the operation on the accelerator pedal is performed in the scene before a curve, the safety of the vehicle 3 increases.

### Third Embodiment

1. Differences from First Embodiment

Since the basic configuration of a third embodiment is similar to the first embodiment, the differences will be described below. Note that the same reference signs as those in the first embodiment indicate the same configuration, and refer to the preceding descriptions.

In the first embodiment described above, all functions of the automated driving are turned off in step S3 when a positive determination is made in step S11. In contrast, in the third embodiment, when a positive determination is made in step S11, the function of lateral control is continued for a predetermined time in step S3 while the other functions of the automated driving are turned off. The lateral control is a control of steering. When a positive determination is made in step S2, all functions of the automated driving are turned off, for example.

### 2. Effects of the Vehicle Control Device 1

According to the third embodiment described in detail above, the following effects are further obtained in addition to the effects of the first embodiment described above.

(3A) When the driver performs the specific operation in the specific scene, the vehicle control device 1 continues the function of the lateral control for the predetermined time. As a result, the safety of the vehicle 3 increases. Especially, when the specific operation is performed while the vehicle 3 is changing lanes in the scene at an entrance ramp or the scene at an exit ramp, the function of the lateral control is continued for the predetermined time, and accordingly the safety of the vehicle 3 increases.

### Other Embodiments

Although the embodiments of the present disclosure have been described above, the present disclosure is not limited to the embodiments described above, and various modifications can be made to implement the present disclosure.

(1) The specific operation may be a combination of the operation on the accelerator pedal and another driving operation. The driving operation may include other operations than the operation on the steering wheel.

(2) The accelerator threshold value may be constant.

The vehicle control device 1 and the technique according to the present disclosure may be achieved by a dedicated computer provided by constituting a processor and a memory programmed to execute one or more functions embodied by a computer program. Alternatively, the vehicle control device 1 and the technique according to the present disclosure may be achieved by a dedicated computer provided by constituting a processor with one or more dedicated hardware logic circuits. Alternatively, the vehicle control device 1 and the technique according to the present disclosure may be achieved using one or more dedicated computers constituted by a combination of the processor and the memory programmed to execute one or more functions and the processor with one or more hardware logic circuits. Further, the computer program may be stored in a computer-readable non-transitory tangible storage medium as instructions to be executed by a computer. The technique for realizing the functions of the respective units included in the vehicle control device 1 does not necessarily need to include software, and all of the functions may be realized with the use of one or multiple hardware.

(4) A plurality of functions of one element in the above embodiment may be implemented by a plurality of elements, or one function of one element may be implemented by a plurality of elements. Further, a plurality of functions of a plurality of elements may be implemented by one element, or one function implemented by a plurality of elements may be implemented by one element. A part of the configuration of the above embodiments may be omitted. At least a part of the configuration of the above embodiments may be added to or replaced with another configuration of the above embodiments.

(5) The present disclosure can be realized in various forms, in addition to the control apparatus described above, such as a system including the vehicle control device 1 as a component, a program for causing a computer to function as the vehicle control device 1, a non-transitory tangible storage medium such as a semiconductor memory storing the program, or a control method of a vehicle control device.

What is claimed is:

1. A vehicle control device for a vehicle configured to perform an automated driving and a manual driving, the vehicle control device comprising:
a specific scene determination unit configured to determine whether the vehicle is in a specific scene that is predetermined;
a specific operation determination unit configured to determine whether a driver of the vehicle performed a specific operation including an operation on an accelerator pedal; and
a function-off unit configured to turn off at least one of functions of the automated driving when the specific scene determination unit determines that the vehicle is in the specific scene and the specific operation determination unit determines that the driver performed the specific operation during the automated driving, wherein
the specific operation includes an operation on the accelerator pedal with a depression amount of the accelerator pedal exceeding an accelerator threshold value, and
the vehicle control device further comprises:
a threshold value setting unit configured to set the accelerator threshold value depending on a scene where the vehicle is traveling.

2. A vehicle control device for a vehicle configured to perform an automated driving and a manual driving, the vehicle control device comprising:
a specific scene determination unit configured to determine whether the vehicle is in a specific scene that is predetermined;
a specific operation determination unit configured to determine whether a driver of the vehicle performed a specific operation including an operation on an accelerator pedal; and
a function-off unit configured to turn off at least one of functions of the automated driving when the specific scene determination unit determines that the vehicle is in the specific scene and the specific operation determination unit determines that the driver performed the specific operation during the automated driving, wherein
the specific operation includes an operation on the accelerator pedal with a depression amount of the accelerator pedal exceeding an accelerator threshold value, and
the vehicle control device further comprises:
a threshold value display unit configured to display the accelerator threshold value.

3. A vehicle control device for a vehicle configured to perform an automated driving and a manual driving, the vehicle control device comprising:
a specific scene determination unit configured to determine whether the vehicle is in a specific scene that is predetermined;
a specific operation determination unit configured to determine whether a driver of the vehicle performed a specific operation including an operation on an accelerator pedal; and
a function-off unit configured to turn off at least one of functions of the automated driving when the specific scene determination unit determines that the vehicle is in the specific scene and the specific operation determination unit determines that the driver performed the specific operation during the automated driving, wherein
the specific operation includes an operation on the accelerator pedal continuing for a predetermined time.

4. A vehicle control device for a vehicle configured to perform an automated driving and a manual driving, the vehicle control device comprising:
a specific scene determination unit configured to determine whether the vehicle is in a specific scene that is predetermined;
a specific operation determination unit configured to determine whether a driver of the vehicle performed a specific operation including an operation on an accelerator pedal;
a function-off unit configured to turn off at least one of functions of the automated driving when the specific scene determination unit determines that the vehicle is in the specific scene and the specific operation determination unit determines that the driver performed the specific operation during the automated driving; and
a notification unit configured to notify a turn off of the at least one of the functions of the automated driving before the function-off unit turns off the at least one of the functions.

5. The vehicle control device according to claim 1, wherein
the specific operation is a combination of the operation on the accelerator pedal and an operation on a steering wheel.

6. The vehicle control device according to claim 5, wherein
the specific scene includes a scene where the vehicle is traveling into a curve.

7. The vehicle control device according to claim 1, wherein
the specific scene includes at least one of a scene at an entrance ramp or a scene at an exit ramp.
